(19) United States
(12) Patent Application Publication
(10) Pub. No.: US 2019/0143355 A1
(43) Pub. Date: May 16, 2019

(54) Pressurized Fluid Delivery Systems and Methods for Using Same

(71) Applicant: Damian Antone Bollermann, Castle Valley, UT (US)

(72) Inventor: Damian Antone Bollermann, Castle Valley, UT (US)

(21) Appl. No.: 15/812,920

(22) Filed: Nov. 14, 2017

(51) Int. Cl. B05B 12/08; G05D 16/20; B05B 1/30

(52) U.S. Cl. CPC B05B 12/085; B05B 1/30; G05D 16/208

(57) ABSTRACT

Disclosed are systems and methods for controlling fluid pressure. A predetermined output pressure is assigned to at least one selected outlet, and a command signal is sent to a supply pump positioned in fluid communication with the selected outlet. The command signal corresponds to an optimized flow profile having at least one flow characteristic configured to discharge a pressurized fluid medium from the selected outlet at the predetermined output pressure. The pressurized fluid medium is released to at least one conduit in fluid communication with the selected outlet in accordance with the optimized flow profile, and the pressurized fluid medium is discharged from the selected outlet at the predetermined output pressure.

### FIELD

This disclosure relates generally to fluid delivery systems and methods, and more particularly, to systems and methods for controlling optimal delivery pressures.

### BACKGROUND

In conventional pressurized fluid delivery systems, pumping and piping systems are often employed, and significant energy is consumed in order to provide fluid at suitable volumes and pressures at distributed delivery locations associated with such pressurized fluid delivery systems. Typically, in such systems, an optimal delivery pressure at one delivery location may be different than an optimal delivery pressure at another delivery location, where both delivery locations are supplied with pressurized fluid by, at least to some degree, a shared pumping and piping system. Such differences in optimal delivery pressures can occur when, for example, the type of apparatus employed at one delivery location requires an optimal delivery pressure different from the type of apparatus employed at another delivery location, or the elevation of one delivery location is different from the elevation of another delivery location resulting in higher pressures at lower elevations and lower pressures at higher elevations, etc. Flow losses in piping systems may result in lower delivery pressures at delivery locations served by portions of a piping system exhibiting larger aggregate piping pressure losses and higher delivery pressures at delivery locations served by portions of a piping system exhibiting lesser aggregate piping pressure losses such that a pressure output by a pumping system may not deliver equal delivery pressures to all delivery locations associated with a given fluid pumping and piping system. It is common practice to provide pressure reducing valves or the like to reduce pressure in portions of the piping system that serve delivery locations where lesser delivery pressure is desired, resulting in energy losses.

Thus, there is a need for improved fluid delivery systems and methods that address one or more of the aforementioned problems and other shortcomings associated with conventional fluid delivery systems.

### SUMMARY

Described herein, in various aspects, is a fluid control system having a supply pump, at least one conduit, a plurality of outlets, and a system controller. The supply pump can be configured to release a pressurized fluid medium in response to a command signal. The at least one conduit can be in fluid communication with the supply pump and configured to deliver the pressurized fluid medium released from the supply pump. The plurality of outlets can be in fluid communication with the at least one conduit and configured to discharge, from at least one selected outlet of the plurality of outlets, the pressurized fluid medium delivered from the at least one conduit. The system controller can be communicatively coupled to the supply pump and configured to output the command signal to the supply pump. The command signal can correspond to an optimized flow profile comprising at least one flow characteristic that is configured to discharge the pressurized fluid medium from the at least one selected outlet of the plurality of outlets at a predetermined output pressure. Upon receipt of the command signal from the system controller, the supply pump can release the pressurized fluid medium for delivery to the at least one selected outlet in accordance with the optimized flow profile.

In additional aspects, described herein is a fluid control system having a supply pump, at least one conduit, a plurality of outlets, a system controller, and a plurality of sensors. The supply pump can be configured to release a pressurized fluid medium in response to a command signal. The at least one conduit can be in fluid communication with the supply pump and configured to deliver the pressurized fluid medium released from the supply pump. The plurality of outlets can be in fluid communication with the at least one conduit and configured to discharge, from at least one selected outlet of the plurality of outlets, the pressurized fluid medium delivered from the at least one conduit. The system controller can be communicatively coupled to the supply pump and configured to output the command signal to the supply pump. The plurality of sensors can be communicatively coupled to the system controller. Each sensor can be positioned in fluid communication with a respective outlet of the plurality of outlets and configured to produce a feedback signal indicative of a first output pressure measured at the at least one selected outlet. The system controller can be configured to receive the feedback signal from the respective sensor, and in response, output the command signal to the supply pump. The command signal can correspond to an optimized flow profile comprising at least one flow characteristic that is configured to discharge the pressurized fluid medium from the at least one selected outlet at a second output pressure that is different from the first output pressure.

Also described is a method of controlling fluid pressure. The method can include assigning a predetermined output pressure to at least one selected outlet. The method can also include outputting a command signal to a supply pump positioned in fluid communication with the at least one selected outlet. The command signal can correspond to an optimized flow profile comprising at least one flow characteristic that is configured to discharge a pressurized fluid medium from the at least one selected outlet at the predetermined output pressure. Upon receipt of the command signal, the method can further include releasing the pressurized fluid medium from the supply pump to at least one conduit in fluid communication with the at least one selected outlet in accordance with the optimized flow profile. Once the at least one selected outlet receives the pressurized fluid medium, the method can further include discharging the pressurized fluid medium from the at least one selected outlet at the predetermined output pressure.

In additional aspects, disclosed herein is another method of controlling fluid pressure. The method can also sending a feedback signal indicative of a first output pressure measured at at least one selected outlet of a plurality of outlets. In response to receiving the feedback signal, the method can further include assigning a second output pressure to the at least one selected outlet that is different from the first output pressure. The method can further include outputting a command signal to a supply pump in fluid communication with the plurality of outlets. The command signal can correspond to an optimized flow profile comprising at least one flow characteristic that is configured to discharge a pressurized fluid medium from the at least one selected outlet at the second output pressure. Upon receipt of the command signal, the method can further include releasing the pressurized fluid medium from the supply pump to the at least one selected outlet in accordance with the optimized flow profile and discharging the pressurized fluid medium from the at least one selected outlet at the second output pressure.

Additional advantages of the disclosure will be set forth in part in the description which follows, and in part will be obvious from the description, or may be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DESCRIPTION OF THE DRAWINGS

The accompanying drawings, which are incorporated in and constitute a part of this specification, illustrate embodiments and together with the description, serve to explain the principles of the methods and systems:

FIG. 1 is a diagram of an exemplary fluid control system as disclosed herein.

FIG. 2 is a diagram of another exemplary fluid control system as disclosed herein.

FIG. 3 is a diagram of another exemplary fluid control system as disclosed herein.

FIG. 4 is a diagram of another exemplary fluid control system as disclosed herein.

FIG. 5 is a diagram of another exemplary fluid control system as disclosed herein.

FIG. 6 is a diagram of another exemplary fluid control system as disclosed herein.

FIG. 7 is a flowchart of an exemplary method of controlling fluid pressure as disclosed herein.

FIG. 8 is a flowchart of another exemplary method of controlling fluid pressure as disclosed herein.

FIG. 9 is a block diagram of an exemplary computer as disclosed herein.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

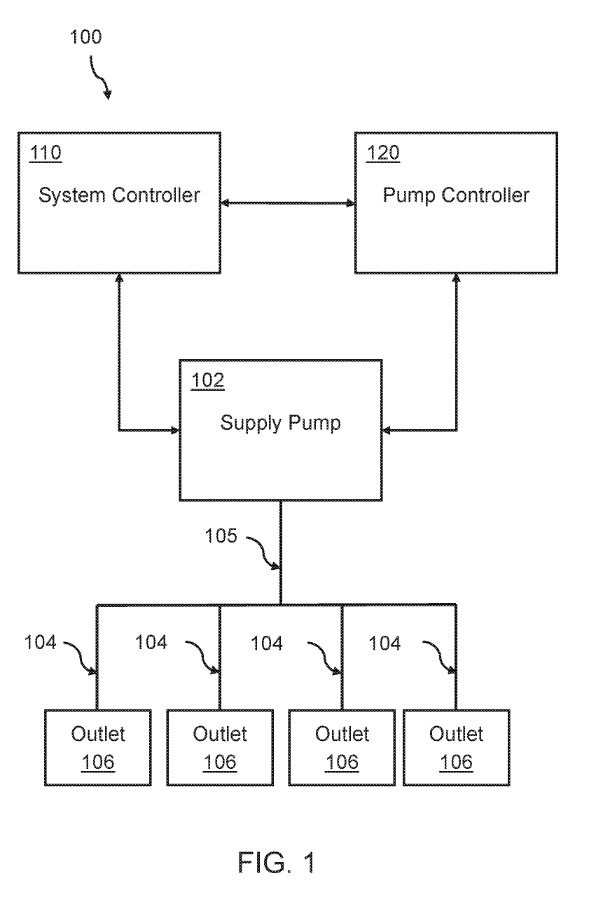

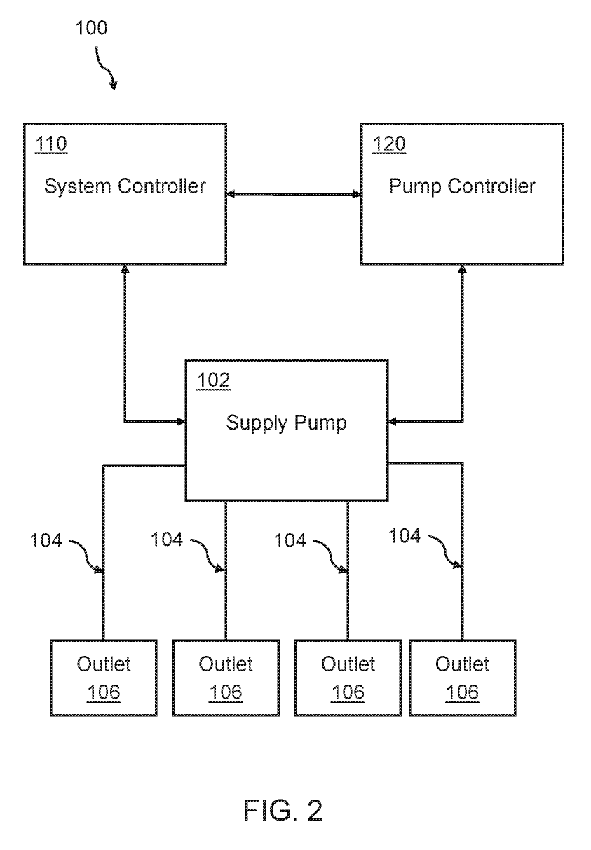

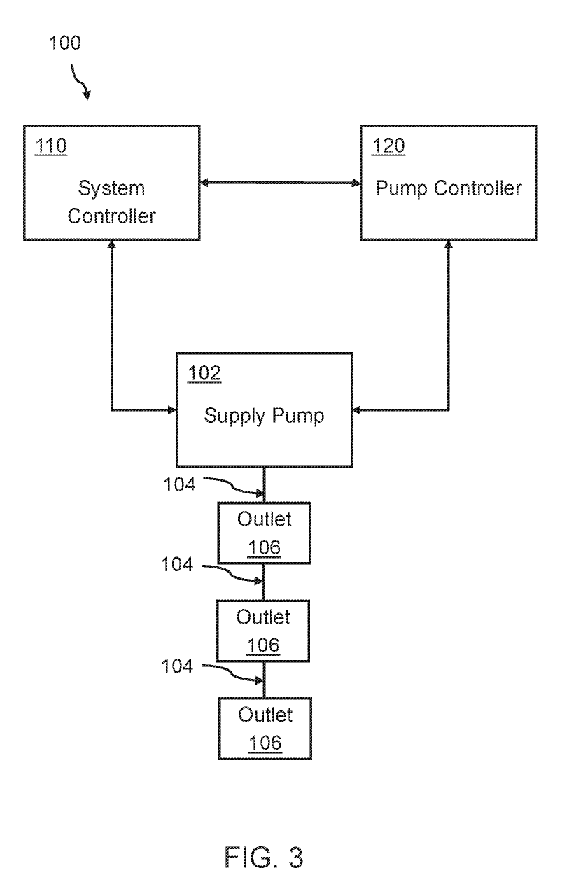

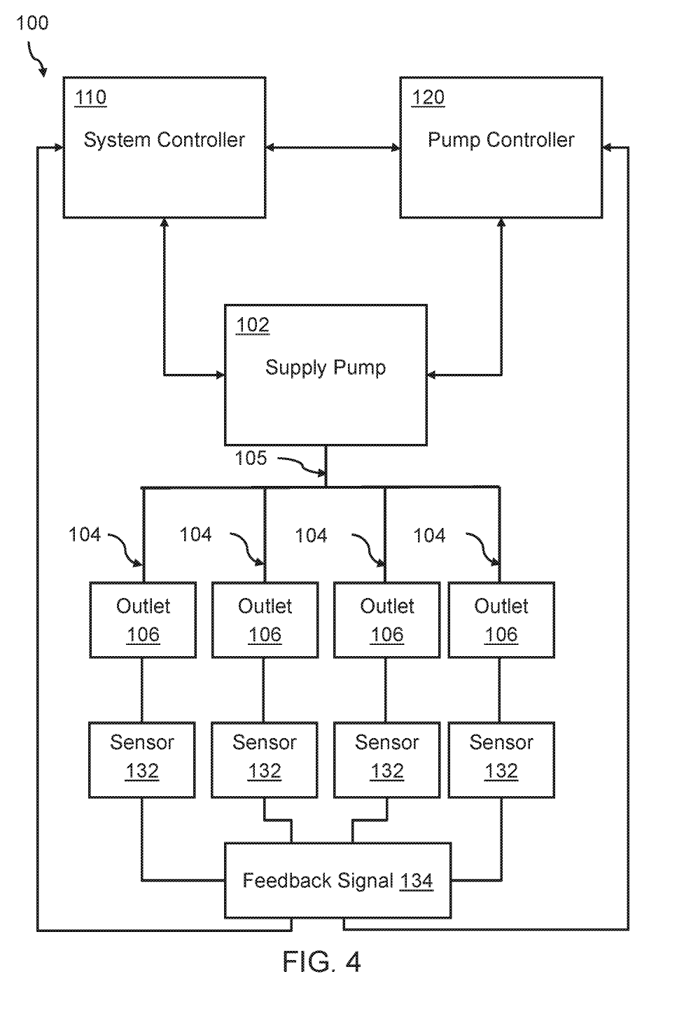

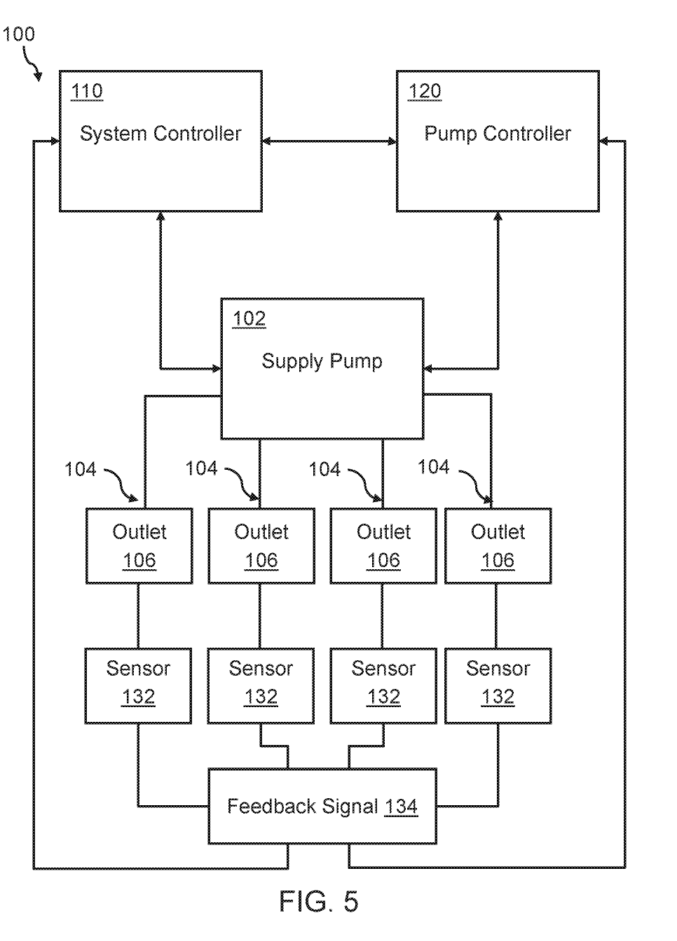

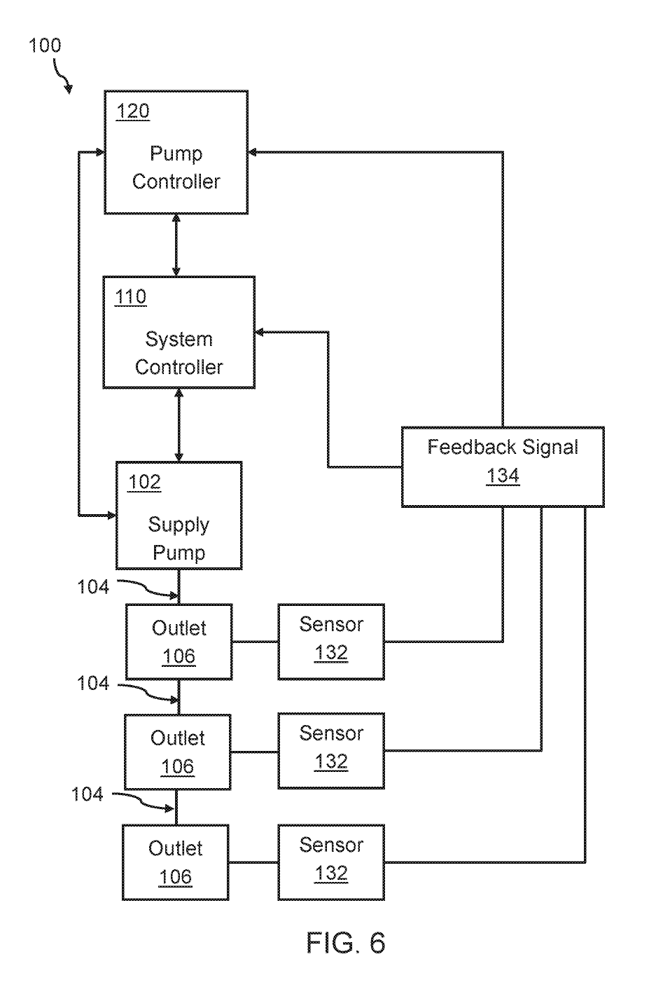

Disclosed herein, in various aspects and with references to FIGS. 1-9, are fluid control systems and methods of using the disclosed fluid control systems. In exemplary aspects, as shown in FIGS. 1-6, a fluid control system 100 can include a supply pump 102. The supply pump 102 can be configured to release a pressurized fluid medium in response to a command signal 112. It is contemplated that the pressurized fluid medium can be a liquid, a gas, or a combination of both. It is further contemplated that the supply pump 102 can comprise a controllable discharge pressure, volume, and/or flow rate, as further disclosed herein. In another aspect, the fluid control system 100 can also include at least one conduit 104, such as a pipe, in fluid communication with the supply pump 102. The at least one conduit 104 can be configured to deliver the pressurized fluid medium released from the supply pump 102 to a respective outlet of a plurality of outlets 106, as described in further detail below. It is contemplated that the at least one conduit 104 can define a plurality of conduits 104 in fluid communication with the supply pump 102, with each conduit being configured to deliver the pressurized fluid medium released from the supply pump to the respective outlet 106. FIGS. 1 and 4 depict a fluid control system 100 having a main conduit 105 in fluid communication with the supply pump 102 and configured to deliver the pressurized fluid medium released from the supply pump to the plurality of conduits 104. FIGS. 2 and 5 depict a fluid control system 100 having a plurality of conduits 104, each conduit positioned in fluid communication with the supply pump 102 and configured to deliver the pressurized fluid medium released from the supply pump. FIGS. 3 and 6 depict a fluid control system 100 having one conduit configured to deliver the pressurized fluid medium released from the supply pump 102 to each outlet 106, as further described herein.

In a further aspect, the fluid control system 100 can include a plurality of outlets 106 in fluid communication with the at least one conduit 104. In this aspect, each conduit of the plurality of conduits 104 can define a respective outlet of the plurality of outlets 106. It is understood that each conduit 104 can define a fluid pathway 122 through which a fluid medium released from the supply pump 102 flows for delivery to the respective outlet 106. The plurality of outlets 106 can be configured to discharge, from at least one selected outlet of the plurality of outlets, the pressurized fluid medium delivered from the at least one conduit 104. It is contemplated that each outlet of the plurality of outlets 106 can comprise an opening 108 through which fluid can exit from the fluid pathway 122 to a delivery location 140 such as a residential or commercial lawn. It is further contemplated each outlet of the plurality of outlets can comprise a nozzle.

In still a further aspect, the fluid control system 100 can include a system controller 110 communicatively coupled to the supply pump 102 and configured to output the command signal 112 to the supply pump. In one aspect, the command signal 112 can correspond to an optimized flow profile 114 comprising at least one flow characteristic 116 that is configured to discharge the pressurized fluid medium from the at least one selected outlet of the plurality of outlets 106 at a predetermined output pressure 118. In an aspect, the system controller 110 can be operable to selectively adjust the at least one flow characteristic 116 of the pressurized fluid medium released by the supply pump 102 based upon a desired output pressure from the at least one selected outlet. It is contemplated that the predetermined output pressure 118 can range from about 10 psi to about 100 psi, from about 60 psi to about 100 psi, from about 30 psi to about 60 psi, or from about 10 psi to about 30 psi. Optionally, in some aspects, it is contemplated that the predetermined output pressure 118 for each outlet 106 of the at least one selected outlets can vary. Alternatively, it is also contemplated that the predetermined output pressure 118 for each outlet 106 can be the same. Upon receipt of the command signal 112 from the system controller 110, the supply pump 102 can release the pressurized fluid medium for delivery to the at least one selected outlet of the plurality of outlets 106 in accordance with the optimized flow profile 114. In these aspects, the at least one flow characteristic 116 can comprise at least one of a starting fluid flow rate, a starting fluid volume, a starting fluid pressure, and combinations thereof, of the pressurized fluid medium released by the supply pump 102. In one aspect, the at least one flow characteristic 116 can comprise a starting fluid pressure of the pressurized fluid medium released by the supply pump 102. In this aspect, the starting fluid pressure can correspond to the predetermined output pressure 118 at the at least one selected outlet of the plurality of outlets 106. In another aspect, the at least one flow characteristic 116 can comprise a starting fluid flow rate of the pressurized fluid medium released by the supply pump 102. In this aspect, the starting fluid flow rate can correspond to the predetermined output pressure 118 at the at least one selected outlet of the plurality of outlets 106. In still another aspect, the at least one flow characteristic 116 can comprise a starting fluid volume of the pressurized fluid medium released by the supply pump 102. In this aspect, the starting fluid volume can correspond to the predetermined output pressure 118 at the at least one selected outlet of the plurality of outlets 106.

It is contemplated that the system controller 110 can include any combination of hardware, software, computing devices, embedded software, or circuitry configured to regulate the flow characteristic 116 of the pressurized fluid medium released by the supply pump 102. In one aspect, the system controller 110 can include a processor, which can be provided as a component of a computing device, such as a personal computer, a laptop computer, a tablet, a smartphone, a programmable logic controller, and the like. For example, the system controller 110 can comprise at least one programmable logic controller that can be communicatively coupled to a motor(s) of the supply pump 102. Although the system controller 110 is depicted as being communicatively coupled to the supply pump 102 and/or the plurality of sensors 132 in the fluid control system 100, it is understood that FIGS. 1-6 serve as exemplary depictions and that the system controller can be communicatively coupled to any other component of the fluid control system, or combinations thereof, in order to perform the disclosed functions.

It is contemplated that the fluid control system 100 can comprise a pump controller 120 for controlling the motor(s) that drives the release of fluid from the supply pump 102. The pump controller 120 can coordinate the release of pressurized fluid from the supply pump 102 with the fluid control system 100. Optionally, the pump controller 120 can be communicatively coupled to the system controller 110 and configured to receive the command signal 112 from the system controller 110. In this optional aspect, in response to receiving the command signal 112 from the system controller 110, the pump controller 120 can trigger release of the pressurized fluid medium from the supply pump 102. It is contemplated that the pump controller 120 can include a processor, which can be provided as a component of a computing device, such as a personal computer, a laptop computer, a tablet, a smartphone, a programmable logic controller, and the like. Alternatively, the system controller 110 and the pump controller 120 can comprise a single processing unit.

Optionally, in some aspects, the fluid control system 100 can further comprise a plurality of fluid control valves 124 (not shown) in fluid communication with the plurality of outlets 106. In these aspects, each fluid control valve 124 can be positioned upstream of a respective outlet 106 and configured to control flow of the pressurized fluid medium from the supply pump 102 to the at least one selected outlet. It is contemplated that each fluid control valve 124 can comprise a valve drive mechanism 126 adapted to effect movement of the fluid control valve 124 between an open position and a closed position. It is further contemplated that the valve drive mechanism 126 can be operatively coupled to the system controller 110. In one aspect, the system controller 110 can be configured to send a stop signal 128 to at least one fluid control valve 124 to effect movement of the at least one valve from the open position toward the closed position. Such closure of the at least one fluid control valve 124 can prevent flow of the pressurized fluid medium to the corresponding outlet 106. The remaining fluid control valves 124 can be configured to remain in the open position to permit delivery of the pressurized fluid medium to the outlets 106 corresponding to the remaining fluid control valves 124. In another aspect, the system controller 110 can be configured to send a flow signal 130 to a fluid control valve 124 corresponding to the at least one selected outlet of the plurality of outlets 106 to effect movement of the at least one fluid control valve 124 from the closed position toward the open position, thereby permitting flow of the pressurized fluid medium to the at least one selected outlet of the plurality of outlets 106.

In some exemplary aspects, as shown in FIGS. 4-6, it is contemplated that the fluid control system 100 can comprise a plurality of sensors 132 communicatively coupled to the system controller 110 and/or the pump controller 120. Each sensor 132 can be positioned in fluid communication with a respective outlet of the plurality of outlets 106 and configured to produce a feedback signal 134 indicative of a first output pressure 136 measured at at least one selected outlet. In these exemplary aspects, the system controller 110 can be configured to receive the feedback signal 134 from the respective sensor 132, and in response, output the command signal 112 to the supply pump 102. The command signal 112 can correspond to an optimized flow profile 114 comprising at least one flow characteristic 116 that is configured to discharge the pressurized fluid medium from the at least one selected outlet at a second output pressure 138 that is different from the first output pressure 136. It is contemplated that the second output pressure 138 can be any desired pressure such as, for example, an output pressure ranging from about 10 psi to about 100 psi, or from about 60 psi to about 100 psi, or from about 30 psi to about 60 psi, or from about 10 psi to about 30 psi. In these aspects, it is contemplated that the second output pressure 138 for each outlet of the plurality of outlets 106 can either be the same or vary.

Advantages of the disclosed fluid control system 100 are apparent. For example, in the case of pumped irrigation systems, it is common practice to pressurize the system with a pump to an output pressure that works well for the point of delivery requiring the highest output pressure, for example a sprinkler at the top of a hill that requires such output pressure to achieve a desired throw distance. In such systems, pressure regulating valves are used to reduce pressure at other points of delivery requiring less pressure such as another sprinkler at the bottom the same hill where the pressure would naturally be higher and where the increased pressure is unneeded or even counterproductive. Since these different points of delivery can be operated at different times, it is more energy efficient to establish a correlation between pressure provided by the supply pump and the point(s) of delivery in operation at any given time. When delivery points requiring higher pressure are operated, the disclosed fluid control system 100 can provide a higher pressure throughout the system, and when delivery points requiring lower pressure are operated, the system can provide a lower pressure throughout the system. In these aspects, it is contemplated that the fluid delivery locations (or plurality of outlets 106) can be sorted by optimal pumping station discharge pressures, and the fluid control system can be maintained at a pressure appropriate to and determined by the delivery location or like sorted locations in operation and receiving fluid delivery at any given time. Such arrangements of delivery locations can provide significant energy savings.

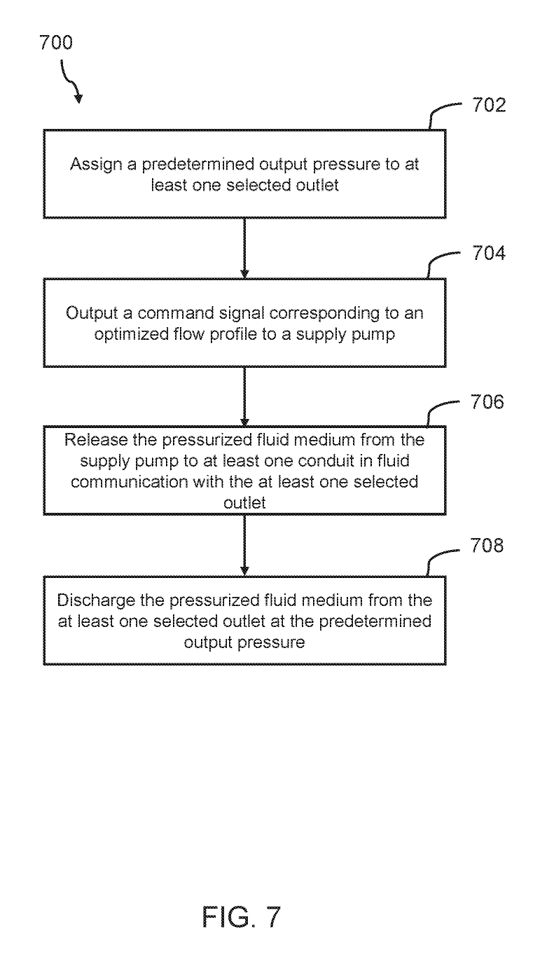

FIG. 7 is a flowchart depicting an exemplary method for controlling fluid pressure. Beginning with step 702, a predetermined output pressure 118 can be assigned to at least one selected outlet of the plurality of outlets 106. In step 704, a command signal 112 can be sent to a supply pump 102 positioned in fluid communication with the at least one selected outlet. As further disclosed herein, the command signal 112 can correspond to an optimized flow profile 114 comprising at least one flow characteristic 116 that is configured to discharge a pressurized fluid medium from the at least one selected outlet 106 at a predetermined output pressure 118. In one aspect, outputting the command signal 112 to the supply pump 102 can be performed by a system controller 110 (or pump controller 120) communicatively coupled to the supply pump 102. The system controller 110 can be operable to modify the optimized flow profile 114 to achieve discharge of the pressurized fluid medium form the at least one selected outlet at the predetermined output pressure 118. As described in further detail above, the at least one flow characteristic 116 can comprise at least one of a starting fluid flow rate, a starting fluid volume, a starting fluid pressure, and combinations thereof, of the pressurized fluid medium released by the supply pump 102.

Next, in step 706, the pressurized fluid medium can be released from the supply pump 102 to at least one conduit 104 in fluid communication with the at least one selected outlet 106 in accordance with the optimized flow profile 114. In step 708, the pressurized fluid medium can be discharged from the at least one selected outlet 106 at the predetermined output pressure 118. Optionally, as further described herein, at least one fluid control valve 124 can be fluidly coupled to the at least one selected outlet, and the at least one fluid control valve 124 can be moveable between an open position and a closed position to control flow of the pressurized fluid medium from the supply pump 102 to the at least one selected outlet 106. In this optional aspect, an open or flow signal 130 can be sent to the at least one fluid control valve 124 to effect movement of the at least one fluid control valve from the closed position toward the open position, thereby permitting flow of the pressurized fluid medium to the at least one selected outlet 106. Alternatively, a stop signal 128 can be sent to the at least one fluid control valve 124 to effect movement of the at least one fluid control valve from the open position toward the closed position, thereby preventing flow of the pressurized fluid medium to the at least one selected outlet 106.

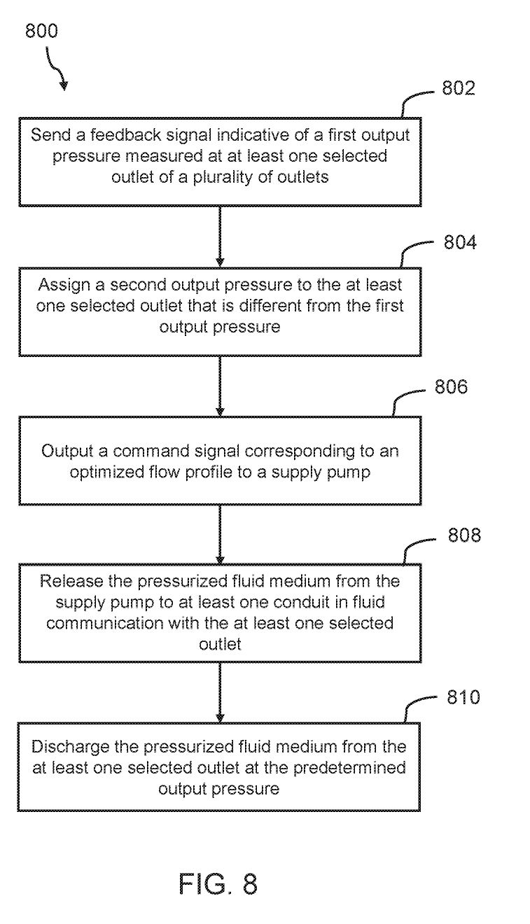

FIG. 8 is a flowchart depicting another exemplary method for controlling fluid pressure. Beginning with step 802, the method can comprise sending a feedback signal 134 indicative of a first output pressure 136 measured at at least one selected outlet of a plurality of outlets 106. In one aspect, sending the feedback signal 134 indicative of the first output pressure 136 can be performed by a sensor 132 communicatively coupled to the system controller 110. As described in further detail herein, the disclosed system 100 can comprise a plurality of sensors 132 communicatively coupled to the system controller 110. Each sensor 132 can be positioned in fluid communication with a respective outlet of the plurality of outlets 106 and configured to produce the feedback signal 134 indicative of the first output pressure 136. In these aspects, the system controller 110 can be configured to receive the feedback signal 134 from the respective sensor. In step 804, in response to receiving the feedback signal 134, a second output pressure 138 can be assigned to the at least one selected outlet 106 that is different from the first output pressure 136. Next, in step 806, a command signal 112 can be sent to a supply pump 102 in fluid communication with the plurality of outlets 106. As further described herein, the command signal 112 can correspond to an optimized flow profile 114 comprising at least one flow characteristic 116 that is configured to discharge a pressurized fluid medium from the at least one selected outlet at the second output pressure 138. In one aspect, outputting the command signal 112 to the supply pump 102 can be performed by a system controller 110 (or pump controller 120) communicatively coupled to the supply pump 102. The system controller 110 can modify the optimized flow profile 114 to achieve discharge of the pressurized fluid medium from the at least one selected outlet at the second output pressure 138. Such modification can be achieved by selectively adjusting the at least one flow characteristic 116 based on the first output pressure 136. As described in further detail above, the at least one flow characteristic 116 can comprise at least one of a starting fluid flow rate, a starting fluid volume, a starting fluid pressure, and combinations thereof, of the pressurized fluid medium released by the supply pump 102.

In step 808, the pressurized fluid medium can be released from the supply pump 102 to at least one conduit 104 in fluid communication with the at least one selected outlet 106 in accordance with the optimized flow profile 114. In step 810, the pressurized fluid medium can be discharged from the at least one selected outlet 106 at the second output pressure 138.

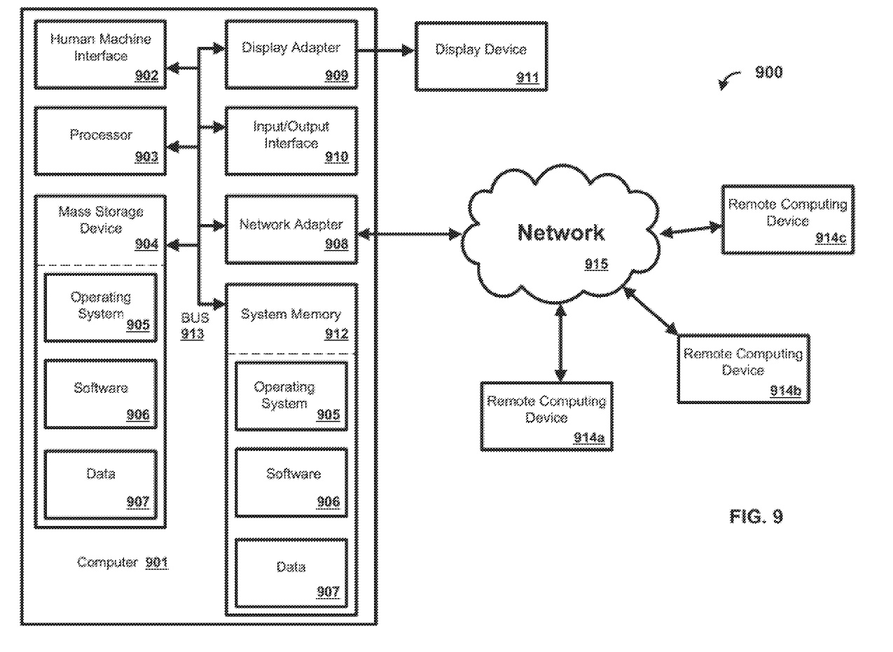

In an exemplary aspect, the methods and systems can be implemented on a computer 901 as illustrated in FIG. 9 and described below. By way of example, system controller 110 of FIG. 1 can be a computer as illustrated in FIG. 9. In a further example, pump controller 120 can be a computer as illustrated in FIG. 9. Similarly, the methods and systems disclosed can utilize one or more computers to perform one or more functions in one or more locations. FIG. 9 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 901. The components of the computer 901 can comprise, but are not limited to, one or more processors 903, a system memory 912, and a system bus 913 that couples various system components including the one or more processors 903 to the system memory 912. The system can utilize parallel computing.

The system bus 913 represents one or more of several possible types of bus structures, including a memory bus or memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 913, and all buses specified in this description can also be implemented over a wired or wireless network connection and each of the subsystems, including the one or more processors 903, a mass storage device 904, an operating system 905, power management software 906, power usage data 907, a network adapter 908, the system memory 912, an Input/Output Interface 910, a display adapter 909, a display device 911, and a human machine interface 902, can be contained within one or more remote computing devices 914a,b,c at physically separate locations, connected through buses of this form, in effect implementing a fully distributed system.

The computer 901 typically comprises a variety of computer readable media. Exemplary readable media can be any available media that is accessible by the computer 901 and comprises, for example and not meant to be limiting, both volatile and non-volatile media, removable and non-removable media. The system memory 912 comprises computer readable media in the form of volatile memory, such as random access memory (RAM), and/or non-volatile memory, such as read only memory (ROM). The system memory 912 typically contains data such as the power usage data 907 and/or program modules such as the operating system 905 and the power management software 906 that are immediately accessible to and/or are presently operated on by the one or more processors 903.

In another aspect, the computer 901 can also comprise other removable/non-removable, volatile/non-volatile computer storage media. By way of example, FIG. 9 illustrates the mass storage device 904 which can provide non-volatile storage of computer code, computer readable instructions, data structures, program modules, and other data for the computer 901. For example and not meant to be limiting, the mass storage device 904 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 904, including by way of example, the operating system 905 and the power management software 906. Each of the operating system 905 and the power management software 906 (or some combination thereof) can comprise elements of the programming and the power management software 906. The power usage data 907 can also be stored on the mass storage device 904. The power usage data 907 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 901 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the one or more processors 903 via the human machine interface 902 that is coupled to the system bus 913, but can be connected by other interface and bus structures, such as a parallel port, game port, an IEEE 1394 Port (also known as a Firewire port), a serial port, or a universal serial bus (USB).

In yet another aspect, the display device 911 can also be connected to the system bus 913 via an interface, such as the display adapter 909. It is contemplated that the computer 901 can have more than one display adapter 909 and the computer 901 can have more than one display device 911. For example, the display device 911 can be a monitor, an LCD (Liquid Crystal Display), or a projector. In addition to the display device 911, other output peripheral devices can comprise components such as speakers (not shown) and a printer (not shown) which can be connected to the computer 901 via the Input/Output Interface 910. Any step and/or result of the methods can be output in any form to an output device. Such output can be any form of visual representation, including, but not limited to, textual, graphical, animation, audio, tactile, and the like. The display device 911 and computer 901 can be part of one device, or separate devices.

The computer 901 can operate in a networked environment using logical connections to one or more remote computing devices 914a,b,c. By way of example, a remote computing device can be a personal computer, portable computer, smartphone, a server, a router, a network computer, a peer device or other common network node, and so on. Logical connections between the computer 901 and a remote computing device 914a,b,c can be made via a network 915, such as a local area network (LAN) and/or a general wide area network (WAN). Such network connections can be through the network adapter 908. The network adapter 908 can be implemented in both wired and wireless environments. Such networking environments are conventional and commonplace in dwellings, offices, enterprise-wide computer networks, intranets, and the Internet.

For purposes of illustration, application programs and other executable program components such as the operating system 905 are illustrated herein as discrete blocks, although it is recognized that such programs and components reside at various times in different storage components of the computing device 901, and are executed by the one or more processors 903 of the computer. An implementation of the power management software 906 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning. Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Exemplary Aspects

In view of the described devices, systems, and methods and variations thereof, herein below are described certain more particularly described aspects of the invention. These particularly recited aspects should not, however, be interpreted to have any limiting effect on any different claims containing different or more general teachings described herein, or that the “particular” aspects are somehow limited in some way other than the inherent meanings of the language literally used therein.

Aspect 1: A fluid control system, comprising: a supply pump configured to release a pressurized fluid medium in response to a command signal; at least one conduit in fluid communication with the supply pump, the at least one conduit being configured to deliver the pressurized fluid medium released from the supply pump; a plurality of outlets in fluid communication with the at least one conduit and configured to discharge from at least one selected outlet of the plurality of outlets the pressurized fluid medium delivered from the at least one conduit; a system controller communicatively coupled to the supply pump and configured to output the command signal to the supply pump, wherein the command signal corresponds to an optimized flow profile comprising at least one flow characteristic that is configured to discharge the pressurized fluid medium from the at least one selected outlet of the plurality of outlets at a predetermined output pressure, and wherein, upon receipt of the command signal from the system controller, the supply pump releases the pressurized fluid medium for delivery to the at least one selected outlet in accordance with the optimized flow profile.

Aspect 2: The fluid control system of aspect 1, wherein the at least one flow characteristic comprises a starting fluid pressure of the pressurized fluid medium released by the supply pump, wherein the starting fluid pressure corresponds to the predetermined output pressure at the at least one selected outlet of the plurality of outlets.

Aspect 3: The fluid control system of aspect 1, wherein the at least one flow characteristic comprises a starting fluid flow rate of the pressurized fluid medium released by the supply pump, wherein the starting fluid flow rate corresponds to the predetermined output pressure at the at least one selected outlet of the plurality of outlets.

Aspect 4: The fluid control system of aspect 1, wherein the at least one flow characteristic comprises a starting fluid volume of the pressurized fluid medium released by the supply pump, wherein the starting fluid volume corresponds to the predetermined output pressure at the at least one selected outlet of the plurality of outlets.

Aspect 5: The fluid control system of any one of the preceding aspects, wherein the system controller is operable to selectively adjust the at least one flow characteristic of the pressurized fluid medium released by the supply pump based upon a desired output pressure from the at least one selected outlet.

Aspect 6: The fluid control system of any one of the preceding aspects, wherein the predetermined output pressure for each outlet of the at least one selected outlets varies.

Aspect 7: The fluid control system of any one of the preceding aspects, wherein the predetermined output pressure for each outlet of the at least one selected outlets is the same.

Aspect 8: The fluid control system of any one of the preceding aspects, further comprising a plurality of fluid control valves in fluid communication with the plurality of outlets, each fluid control valve being positioned upstream of a respective outlet and configured to control flow of the pressurized fluid medium from the supply pump to the at least one selected outlet.

Aspect 9: The fluid control system of aspect 8, wherein each fluid control valve comprises a valve drive mechanism adapted to effect movement of the fluid control valve between an open position and a closed position, wherein the valve drive mechanism is operatively coupled to the system controller.

Aspect 10: The fluid control system of aspect 9, wherein the system controller is configured to send a stop signal to at least one fluid control valve to effect movement of the at least one valve from the open position toward the closed position to prevent flow of the pressurized fluid medium to the outlet corresponding to the at least one fluid control valve.

Aspect 11: The fluid control system of aspect 10, wherein the remaining fluid control valves are configured to remain in the open position to permit delivery of the pressurized fluid medium to the outlets corresponding to the remaining fluid control valves.

Aspect 12: The fluid control system of aspect 9, wherein the system controller is configured to send a flow signal to a fluid control valve corresponding to the at least one selected outlet to effect movement of the at least one fluid control valve from the closed position toward the open position to permit flow of the pressurized fluid medium to the at least one selected outlet.

Aspect 13: The fluid control system of any one of the preceding aspects, wherein the predetermined output pressure ranges from about 10 psi to about 100 psi.

Aspect 14: The fluid control system of aspect 13, wherein the predetermined output pressure ranges from about 60 psi to about 100 psi.

Aspect 15: The fluid control system of aspect 13, wherein the predetermined output pressure ranges from about 30 psi to about 60 psi.

Aspect 16: The fluid control system of aspect 13, wherein the predetermined output pressure ranges from about 10 psi to about 30 psi.

Aspect 17: The fluid control system of any one of the preceding aspects, wherein the at least one conduit defines a plurality of conduits, each conduit of the plurality of conduits defining a respective outlet of the plurality of outlets.

Aspect 18: The fluid control system of any one of the preceding aspects, wherein each outlet of the plurality of outlets comprises an opening through which fluid exits from a fluid pathway.

Aspect 19: A fluid control system, comprising: a supply pump configured to release a pressurized fluid medium in response to a command signal; at least one conduit in fluid communication with the supply pump, the at least one conduit being configured to deliver the pressurized fluid medium released from the supply pump; a plurality of outlets in fluid communication with the at least one conduit and configured to discharge from at least one selected outlet of the plurality of outlets the pressurized fluid medium delivered from the at least one conduit; a system controller communicatively coupled to the supply pump and configured to output the command signal to the supply pump; and a plurality of sensors communicatively coupled to the system controller, each sensor positioned in fluid communication with a respective outlet of the plurality of outlets and configured to produce a feedback signal indicative of a first output pressure measured at the at least one selected outlet, wherein the system controller is configured to receive the feedback signal from the respective sensor, and in response, output the command signal to the supply pump, wherein the command signal corresponds to an optimized flow profile comprising at least one flow characteristic that is configured to discharge the pressurized fluid medium from the at least one selected outlet at a second output pressure that is different from the first output pressure.

Aspect 20: The fluid control system of aspect 19, wherein the at least one flow characteristic comprises at least one of a starting fluid flow rate, a starting fluid volume, a starting fluid pressure, and combinations thereof, of the pressurized fluid medium released by the supply pump.

Aspect 21: The fluid control system of aspect 19 or aspect 20, wherein the at least one flow characteristic comprises a starting fluid pressure of the pressurized fluid medium released by the supply pump, wherein the starting fluid pressure corresponds to the second output pressure at the at least one selected outlet of the plurality of outlets.

Aspect 22: The fluid control system of aspect 19 or aspect 20, wherein the at least one flow characteristic comprises a starting fluid flow rate of the pressurized fluid medium released by the supply pump, wherein the starting fluid flow rate corresponds to the second output pressure at the at least one selected outlet of the plurality of outlets.

Aspect 23: The fluid control system of aspect 19 or aspect 20, wherein the at least one flow characteristic comprises a starting fluid volume of the pressurized fluid medium released by the supply pump, wherein the starting fluid volume corresponds to the second output pressure at the at least one selected outlet of the plurality of outlets.

Aspect 24: The fluid control system of aspects 19-23, wherein the second output pressure for each outlet of the plurality of outlets varies.

Aspect 25: The fluid control system of aspects 19-23, wherein the second output pressure for each outlet of the plurality of outlets is the same.

Aspect 26: The fluid control system of aspects 19-25, further comprising a plurality of fluid control valves in fluid communication with the plurality of outlets, each fluid control valve being positioned upstream of a respective outlet and configured to control flow of the pressurized fluid medium from the supply pump to the at least one selected outlet.

Aspect 27: The fluid control system of aspect 26, wherein each fluid control valve comprises a valve drive mechanism adapted to effect movement of the fluid control valve between an open position and a closed position, wherein the valve drive mechanism is operatively coupled to the system controller.

Aspect 28: The fluid control system of aspect 27, wherein the system controller is configured to send a stop signal to at least one fluid control valve to effect movement of the at least one valve from the open position toward the closed position to prevent flow of the pressurized fluid medium to the outlet corresponding to the at least one fluid control valve.

Aspect 29: The fluid control system of aspect 28, wherein the remaining fluid control valves are configured to remain in the open position to permit delivery of the pressurized fluid medium to the outlets corresponding to the remaining fluid control valves.

Aspect 30: The fluid control system of aspect 27, wherein the system controller is configured to send a flow signal to a fluid control valve corresponding to the at least one selected outlet to effect movement of the at least one fluid control valve from the closed position toward the open position to permit flow of the pressurized fluid medium to the at least one selected outlet.

Aspect 31: The fluid control system of aspects 19-30, wherein the second output pressure ranges from about 10 psi to about 100 psi.

Aspect 32: The fluid control system of aspect 31, wherein the second output pressure ranges from about 60 psi to about 100 psi.

Aspect 33: The fluid control system of aspect 31, wherein the second output pressure ranges from about 30 psi to about 60 psi.

Aspect 34: The fluid control system of aspect 31, wherein the second output pressure ranges from about 10 psi to about 30 psi.

Aspect 35: The fluid control system of aspects 19-34, wherein the at least one conduit defines a plurality of conduits, each conduit of the plurality of conduits defining a respective outlet of the plurality of outlets.

Aspect 36: The fluid control system of aspects 19-35, wherein each outlet of the plurality of outlets comprises an opening through which fluid exits from a fluid pathway.

Aspect 37: A method of controlling fluid pressure, comprising: assigning a predetermined output pressure to at least one selected outlet; outputting a command signal to a supply pump positioned in fluid communication with the at least one selected outlet, the command signal corresponding to an optimized flow profile comprising at least one flow characteristic that is configured to discharge a pressurized fluid medium from the at least one selected outlet at a predetermined output pressure; releasing the pressurized fluid medium from the supply pump to at least one conduit in fluid communication with the at least one selected outlet in accordance with the optimized flow profile; and discharging the pressurized fluid medium from the at least one selected outlet at the predetermined output pressure.

Aspect 38: The method of aspect 37, wherein outputting the command signal to the supply pump is performed by a system controller communicatively coupled to the supply pump, wherein the system controller is operable to modify the optimized flow profile to achieve discharge of the pressurized fluid medium from the at least one selected outlet at the predetermined output pressure.

Aspect 39: The method of aspect 37 or aspect 38, wherein the at least one flow characteristic comprises a starting fluid pressure of the pressurized fluid medium released by the supply pump, wherein the starting fluid pressure corresponds to the predetermined output pressure at the at least one selected outlet.

Aspect 40: The method of aspect 37 or aspect 38, wherein the at least one flow characteristic comprises a starting fluid flow rate of the pressurized fluid medium released by the supply pump, wherein the starting fluid flow rate corresponds to the predetermined output pressure at the at least one selected outlet.

Aspect 41: The method of aspect 37 or aspect 38, wherein the at least one flow characteristic comprises a starting fluid volume of the pressurized fluid medium released by the supply pump, wherein the starting fluid volume corresponds to the predetermined output pressure at the at least one selected outlet.

Aspect 42: The method of aspects 37-41, wherein at least one fluid control valve is fluidly coupled to the at least one selected outlet, the at least one fluid control valve being moveable between an open position and a closed position to control flow of the pressurized fluid medium from the supply pump to the at least one selected outlet.

Aspect 43: The method of aspect 42, further comprising sending a flow signal to the at least one fluid control valve to effect movement of the at least one valve from the closed position toward the open position, thereby permitting flow of the pressurized fluid medium to the at least one selected outlet.

Aspect 44: The method of aspect 42, further comprising sending a stop signal to the at least one fluid control valve to effect movement of the at least one valve from the open position toward the closed position, thereby preventing flow of the pressurized fluid medium to the at least one selected outlet.

Aspect 45: A method of controlling fluid pressure, comprising: sending a feedback signal indicative of a first output pressure measured at at least one selected outlet of a plurality of outlets; in response to receiving the feedback signal, assigning a second output pressure to the at least one selected outlet that is different from the first output pressure; outputting a command signal to a supply pump in fluid communication with the plurality of outlets, the command signal corresponding to an optimized flow profile comprising at least one flow characteristic that is configured to discharge a pressurized fluid medium from the at least one selected outlet at the second output pressure; releasing the pressurized fluid medium from the supply pump to at least one conduit in fluid communication with the at least one selected outlet in accordance with the optimized flow profile; and discharging the pressurized fluid medium from the at least one selected outlet at the second output pressure.

Aspect 46: The method of aspect 45, wherein outputting the command signal to the supply pump is performed by a system controller communicatively coupled to the supply pump.

Aspect 47: The method of aspect 46, wherein sending the feedback signal indicative of the first output pressure is performed by a sensor communicatively coupled to the system controller.

Aspect 48: The method of aspect 46, wherein the system controller is configured to selectively adjust the at least one flow characteristic based on the first output pressure, and wherein the at least one flow characteristic comprises at least one of a starting fluid flow rate, a starting fluid volume, and a starting fluid pressure, of the pressurized fluid medium released by the supply pump.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A fluid control system, comprising:
a supply pump configured to release a pressurized fluid medium in response to a command signal;
at least one conduit in fluid communication with the supply pump, the at least one conduit being configured to deliver the pressurized fluid medium released from the supply pump;
a plurality of outlets in fluid communication with the at least one conduit and configured to discharge from at least one selected outlet of the plurality of outlets the pressurized fluid medium delivered from the at least one conduit;
a system controller communicatively coupled to the supply pump and configured to output the command signal to the supply pump,
wherein the command signal corresponds to an optimized flow profile comprising at least one flow characteristic that is configured to discharge the pressurized fluid medium from the at least one selected outlet of the plurality of outlets at a predetermined output pressure, and wherein, upon receipt of the command signal from the system controller, the supply pump releases the pressurized fluid medium for delivery to the at least one selected outlet in accordance with the optimized flow profile.

2. The fluid control system of claim 1, wherein the at least one flow characteristic comprises a starting fluid pressure of the pressurized fluid medium released by the supply pump, wherein the starting fluid pressure corresponds to the predetermined output pressure at the at least one selected outlet of the plurality of outlets.

3. The fluid control system of claim 1, wherein the at least one flow characteristic comprises a starting fluid flow rate of the pressurized fluid medium released by the supply pump, wherein the starting fluid flow rate corresponds to the predetermined output pressure at the at least one selected outlet of the plurality of outlets.

4. The fluid control system of claim 1, wherein the at least one flow characteristic comprises a starting fluid volume of the pressurized fluid medium released by the supply pump, wherein the starting fluid volume corresponds to the predetermined output pressure at the at least one selected outlet of the plurality of outlets.

5. The fluid control system of claim 1, wherein the system controller is operable to selectively adjust the at least one flow characteristic of the pressurized fluid medium released by the supply pump based upon a desired output pressure from the at least one selected outlet.

6. The fluid control system of claim 1, wherein the predetermined output pressure for each outlet of the at least one selected outlets varies.

7. The fluid control system of claim 1, wherein the predetermined output pressure for each outlet of the at least one selected outlets is the same.

8. The fluid control system of claim 1, further comprising a plurality of fluid control valves in fluid communication with the plurality of outlets, each fluid control valve being positioned upstream of a respective outlet and configured to control flow of the pressurized fluid medium from the supply pump to the at least one selected outlet.

9. The fluid control system of claim 8, wherein each fluid control valve comprises a valve drive mechanism adapted to effect movement of the fluid control valve between an open position and a closed position, wherein the valve drive mechanism is operatively coupled to the system controller.

10. The fluid control system of claim 9, wherein the system controller is configured to send a stop signal to at least one fluid control valve to effect movement of the at least one valve from the open position toward the closed position to prevent flow of the pressurized fluid medium to the outlet corresponding to the at least one fluid control valve.

11. The fluid control system of claim 10, wherein the remaining fluid control valves are configured to remain in the open position to permit delivery of the pressurized fluid medium to the outlets corresponding to the remaining fluid control valves.

12. The fluid control system of claim 9, wherein the system controller is configured to send a flow signal to a fluid control valve corresponding to the at least one selected outlet to effect movement of the at least one fluid control valve from the closed position toward the open position to permit flow of the pressurized fluid medium to the at least one selected outlet.

13. The fluid control system of claim 1, wherein the predetermined output pressure ranges from about 10 psi to about 100 psi.

14. The fluid control system of claim 13, wherein the predetermined output pressure ranges from about 60 psi to about 100 psi.

15. The fluid control system of claim 13, wherein the predetermined output pressure ranges from about 30 psi to about 60 psi.

16. The fluid control system of claim 13, wherein the predetermined output pressure ranges from about 10 psi to about 30 psi.

17. The fluid control system of claim 1, wherein the at least one conduit defines a plurality of conduits, each conduit of the plurality of conduits defining a respective outlet of the plurality of outlets.

18. The fluid control system of claim 1, wherein each outlet of the plurality of outlets comprises an opening through which fluid exits from a fluid pathway.

19. A fluid control system, comprising:
a supply pump configured to release a pressurized fluid medium in response to a command signal;
at least one conduit in fluid communication with the supply pump, the at least one conduit being configured to deliver the pressurized fluid medium released from the supply pump;
a plurality of outlets in fluid communication with the at least one conduit and configured to discharge from at least one selected outlet of the plurality of outlets the pressurized fluid medium delivered from the at least one conduit;
a system controller communicatively coupled to the supply pump and configured to output the command signal to the supply pump; and
a plurality of sensors communicatively coupled to the system controller, each sensor positioned in fluid communication with a respective outlet of the plurality of outlets and configured to produce a feedback signal indicative of a first output pressure measured at the at least one selected outlet,
wherein the system controller is configured to receive the feedback signal from the respective sensor, and in response, output the command signal to the supply pump, wherein the command signal corresponds to an optimized flow profile comprising at least one flow characteristic that is configured to discharge the pressurized fluid medium from the at least one selected outlet at a second output pressure that is different from the first output pressure.

20. The fluid control system of claim 19, wherein the at least one flow characteristic comprises at least one of a starting fluid flow rate, a starting fluid volume, and a starting fluid pressure, of the pressurized fluid medium released by the supply pump.

21. The fluid control system of claim 19, wherein the at least one flow characteristic comprises a starting fluid pressure of the pressurized fluid medium released by the supply pump, wherein the starting fluid pressure corresponds to the second output pressure at the at least one selected outlet of the plurality of outlets.

22. The fluid control system of claim 19, wherein the at least one flow characteristic comprises a starting fluid flow rate of the pressurized fluid medium released by the supply pump, wherein the starting fluid flow rate corresponds to the second output pressure at the at least one selected outlet of the plurality of outlets.

23. The fluid control system of claim 19, wherein the at least one flow characteristic comprises a starting fluid volume of the pressurized fluid medium released by the supply pump, wherein the starting fluid volume corresponds to the second output pressure at the at least one selected outlet of the plurality of outlets.

24. The fluid control system of claim 19, wherein the second output pressure for each outlet of the plurality of outlets varies.

25. The fluid control system of claim 19, wherein the second output pressure for each outlet of the plurality of outlets is the same.

26. The fluid control system of claim 19, further comprising a plurality of fluid control valves in fluid communication with the plurality of outlets, each fluid control valve being positioned upstream of a respective outlet and configured to control flow of the pressurized fluid medium from the supply pump to the at least one selected outlet.

27. The fluid control system of claim 26, wherein each fluid control valve comprises a valve drive mechanism adapted to effect movement of the fluid control valve between an open position and a closed position, wherein the valve drive mechanism is operatively coupled to the system controller.

28. The fluid control system of claim 27, wherein the system controller is configured to send a stop signal to at least one fluid control valve to effect movement of the at least one valve from the open position toward the closed position to prevent flow of the pressurized fluid medium to the outlet corresponding to the at least one fluid control valve.

29. The fluid control system of claim 28, wherein the remaining fluid control valves are configured to remain in the open position to permit delivery of the pressurized fluid medium to the outlets corresponding to the remaining fluid control valves.

30. The fluid control system of claim 27, wherein the system controller is configured to send a flow signal to a fluid control valve corresponding to the at least one selected outlet to effect movement of the at least one fluid control valve from the closed position toward the open position to permit flow of the pressurized fluid medium to the at least one selected outlet.

31. The fluid control system of claim 19, wherein the second output pressure ranges from about 10 psi to about 100 psi.

32. The fluid control system of claim 31, wherein the second output pressure ranges from about 60 psi to about 100 psi.

33. The fluid control system of claim 31, wherein the second output pressure ranges from about 30 psi to about 60 psi.

34. The fluid control system of claim 31, wherein the second output pressure ranges from about 10 psi to about 30 psi.

35. The fluid control system of claim 19, wherein the at least one conduit defines a plurality of conduits, each conduit of the plurality of conduits defining a respective outlet of the plurality of outlets.

36. The fluid control system of claim 19, wherein each outlet of the plurality of outlets comprises an opening through which fluid exits from a fluid pathway.

37. A method of controlling fluid pressure, comprising:
assigning a predetermined output pressure to at least one selected outlet;
outputting a command signal to a supply pump positioned in fluid communication with the at least one selected outlet, the command signal corresponding to an optimized flow profile comprising at least one flow characteristic that is configured to discharge a pressurized fluid medium from the at least one selected outlet at a predetermined output pressure;
releasing the pressurized fluid medium from the supply pump to at least one conduit in fluid communication with the at least one selected outlet in accordance with the optimized flow profile; and
discharging the pressurized fluid medium from the at least one selected outlet at the predetermined output pressure.

38. The method of claim 37, wherein outputting the command signal to the supply pump is performed by a system controller communicatively coupled to the supply pump, wherein the system controller is operable to modify the optimized flow profile to achieve discharge of the pressurized fluid medium from the at least one selected outlet at the predetermined output pressure.

39. The method of claim 37, wherein the at least one flow characteristic comprises a starting fluid pressure of the pressurized fluid medium released by the supply pump, wherein the starting fluid pressure corresponds to the predetermined output pressure at the at least one selected outlet.

40. The method of claim 37, wherein the at least one flow characteristic comprises a starting fluid flow rate of the pressurized fluid medium released by the supply pump, wherein the starting fluid flow rate corresponds to the predetermined output pressure at the at least one selected outlet.

41. The method of claim 37, wherein the at least one flow characteristic comprises a starting fluid volume of the pressurized fluid medium released by the supply pump, wherein the starting fluid volume corresponds to the predetermined output pressure at the at least one selected outlet.

42. The method of claim 37, wherein at least one fluid control valve is fluidly coupled to the at least one selected outlet, the at least one fluid control valve being moveable between an open position and a closed position to control flow of the pressurized fluid medium from the supply pump to the at least one selected outlet.

43. The method of claim 42, further comprising sending a flow signal to the at least one fluid control valve to effect movement of the at least one valve from the closed position toward the open position, thereby permitting flow of the pressurized fluid medium to the at least one selected outlet.

44. The method of claim 42, further comprising sending a stop signal to the at least one fluid control valve to effect movement of the at least one valve from the open position toward the closed position, thereby preventing flow of the pressurized fluid medium to the at least one selected outlet.

45. A method of controlling fluid pressure, comprising:
sending a feedback signal indicative of a first output pressure measured at at least one selected outlet of a plurality of outlets;
in response to receiving the feedback signal, assigning a second output pressure to the at least one selected outlet that is different from the first output pressure;
outputting a command signal to a supply pump in fluid communication with the plurality of outlets, the command signal corresponding to an optimized flow profile comprising at least one flow characteristic that is configured to discharge a pressurized fluid medium from the at least one selected outlet at the second output pressure;
releasing the pressurized fluid medium from the supply pump to at least one conduit in fluid communication with the at least one selected outlet in accordance with the optimized flow profile; and
discharging the pressurized fluid medium from the at least one selected outlet at the second output pressure.

46. The method of claim 45, wherein outputting the command signal to the supply pump is performed by a system controller communicatively coupled to the supply pump.

47. The method of claim 46, wherein sending the feedback signal indicative of the first output pressure is performed by a sensor communicatively coupled to the system controller.

48. The method of claim 46, wherein the system controller is configured to selectively adjust the at least one flow characteristic based on the first output pressure, and wherein the at least one flow characteristic comprises at least one of a starting fluid flow rate, a starting fluid volume, and a starting fluid pressure, of the pressurized fluid medium released by the supply pump.
